(19) United States
(12) Patent Application Publication
(10) Pub. No.: US 2025/0235831 A1
(43) Pub. Date: Jul. 24, 2025

(54) SYSTEMS, METHODS, AND APPARATUSES FOR FOAM AIR MIXING

(71) Applicant: Graco Minnesota Inc., Minneapolis, MN (US)

(72) Inventors: Daniel P. Ross, Vadnais Heights, MN (US); Joseph E. Tix, Hastings, MN (US); Andrew M. Spiess, White Bear Lake, MN (US)

(21) Appl. No.: 18/703,556

(22) PCT Filed: Oct. 31, 2022
(86) PCT No.: PCT/US2022/048433

§ 371 Date: Apr. 22, 2024

Related U.S. Application Data
(60) Provisional application No. 63/274,089, filed on Nov. 1, 2021.

(51) Int. Cl. B01F 23/235; B01F 23/232; B01F 25/31; B01F 25/313; B01F 25/4314; B01F 33/501; B01F 101/00; B01F 101/30; B01F 101/36; B05B 7/00

(52) U.S. Cl. CPC B01F 23/235; B01F 23/232; B01F 25/31112; B01F 25/3131; B01F 25/3133; B01F 25/4314; B01F 33/50114; B05B 7/0025; B01F 2101/2805; B01F 2101/30; B01F 2101/36

(57) ABSTRACT

A nozzle assembly includes a nozzle housing (86) defining an inner chamber (91) and a mixer (90) disposed within the inner chamber. The nozzle housing includes a nozzle housing and a nozzle orifice. The nozzle receive is configured to connect to a sprayer housing and to receive a first material, a second material, and air. The nozzle orifice is configured to spray a plural component material formed by a mixture of the first material and the second material. The mixer includes a shaft (92), an extension (94), an air channel, and inlet orifice formed in a first end of the shaft, and an outlet orifice formed between the air channel and a surface of the shaft. The extension defines a mixing channel extending between the shaft and the inner surface of the housing and the air channel is defined by an inner surface of the shaft and extends partially axially through the shaft.

### CROSS-REFERENCE TO RELATED APPLICATION(S)

This application claims the benefit of U.S. Provisional Application No. 63/274,089 filed Nov. 1, 2021 for “LOW PRESSURE FOAM AIR MIXING NOZZLE” by D. Ross, J. Tix, and A. Spiess, the disclosure of which is incorporated in its entirety by reference herein.

### BACKGROUND

This disclosure relates generally to plural component dispensing systems and more particularly to systems, methods, and apparatuses for introducing air to plural component mixtures to dispense plural component materials.

Plural component materials are formed by two or more component materials combining to form the plural component material. The component materials are individually pumped and are combined prior to application. The resultant plural component material can be an insulator, such as foam, or can be paint, sealant, coating, adhesive, etc.

### SUMMARY

According to one aspect of the present disclosure, an example of a nozzle assembly includes a nozzle housing defining an inner chamber and a mixer disposed within the inner chamber. The mixer defines a flow path and comprises an air channel extending partially through the mixer. The air channel is configured to deliver air to a mix point along the flow path.

According to an additional or alternative aspect of the present disclosure, an example of a nozzle assembly includes a nozzle housing defining an inner chamber and a mixer disposed within the inner chamber. The nozzle housing includes a nozzle housing and a nozzle orifice. The nozzle receive is configured to connect to a sprayer housing and to receive a first material, a second material, and air. The nozzle orifice is configured to spray a plural component material formed by a mixture of the first material and the second material. The mixer includes a shaft, an extension, an air channel, and inlet orifice, and an outlet orifice. The shaft is oriented along a shaft axis and has a first end and a second end. The second end is oriented towards the nozzle orifice of the nozzle housing. The extension extends from an outer surface of the shaft to an inner surface of the housing and extending along the shaft, such that the extension defines a channel extending between the shaft and the inner surface of the housing. The air channel is defined by an inner surface of the shaft and extends partially axially through the shaft. The inlet orifice is formed in the first end of the shaft and the outlet orifice is formed through the shaft between the air channel and the outer surface of the shaft at a location between the first end and the second end.

According to an additional or alternative aspect of the present disclosure, an example of a nozzle assembly includes a nozzle housing forming a mixing chamber and structured with one open end for connecting with a path housing and the opposite end with a nozzle orifice for spraying foam. The path housing is configured to receive compressed air, a first fluid component, and a second fluid component, and is structured to be connected to the nozzle housing. The nozzle assembly further includes a mixer structured to fit at least partially within the nozzle housing and to receive compressed air from the path housing. The mixer further includes a central shaft having an internal channel for compressed air, a helical extension arranged around at least a portion of the central shaft, and an air orifice arranged on the central shaft. The helical extension forms at least two helical turns around the central shaft, thereby creating a helical channel. The air orifice is structured to release compressed air from the central shaft at an angle other than a direction of the internal channel.

According to an additional or alternative aspect of the present disclosure, an example of a sprayer includes a spray housing, a nozzle assembly according to another aspect of the present disclosure, and a trigger. The trigger is connected to the sprayer housing and operatively connected to a valve for selectively permitting the flow of at least one of a first material, a second material, and air to the nozzle assembly.

According to an additional or alternative aspect of the present disclosure, an example of a method of spraying a plural component material includes flowing a first material through a helical flow path, flowing a second material through the flow path while flowing the first material through the flow path. The flow path is defined by an interior wall of a nozzle housing and a mixer disposed within the nozzle housing. The method further includes flowing nucleation air through a channel extending through the mixer to an air orifice disposed at a mix point, and mixing the first and the second material with the nucleation air to generate a plural component material. The method further includes spraying the plural component material from a nozzle orifice defined by a first end of the nozzle housing.

According to an additional or alternative aspect of the present disclosure, an example of mixing nozzle for spraying a fluid mixture composed of a first material and a second material includes a nozzle orifice for spraying the fluid mixture, an outer tube defining a mixing chamber, a first material outlet, a second material outlet, a static mixer located within the mixing chamber, and an inner tube extending along the axis within the mixing chamber and at least partially surrounded by the static mixer. The outer tube is coaxial with an axis, the mixing chamber is located upstream of the outlet orifice, and the axis extends through the outlet orifice. The first material outlet is configured to flow the first material to be mixed into the mixing chamber and the second material outlet is configured to flow the second material to be mixed with the first material into the mixing chamber. The inner tube includes a gas outlet orifice for introducing compressed gas to a mixture of the first material and the second material at a mix point along the static mixer. The gas outlet orifice is located along the axis between the upstream terminus and the downstream terminus, and the first material outlet and the second material outlet are both located upstream of the gas outlet orifice.

### BRIEF DESCRIPTION OF THE DRAWINGS

FIG. 1 is a schematic diagram of an example of a plural component dispense system.

FIG. 2 is a schematic cross-sectional view of an example of a dispensing nozzle for a dispenser.

FIG. 3 is an isometric view showing a simplified plural component dispenser suitable for use with the system of FIG. 1.

FIG. 4 is a cross-sectional view taken along line 4-4 in FIG. 5 showing a another dispensing nozzle for a dispenser.

FIG. 5 is a cross-sectional view taken along line 3-3 in FIG. 4.

FIG. 6 is a cross-sectional view of a further nozzle for a dispenser.

FIG. 7 is a plan view of a nozzle mixer.

FIG. 8 is a cross-sectional view of the mixer taken along line 7-7 shown in FIG. 7.

FIG. 9 is a plan view of a mixer showing example locations of an air outlet.

### DETAILED DESCRIPTION

This disclosure is related to systems, methods, and apparatuses for dispensing plural component materials, such as foams, among other options. Multiple component materials are combined at a dispenser to form a heterogenous mixture that is subsequently homogenized and aerated by the introduction of air within the spray nozzle. As will be described subsequently, the systems, methods, and apparatuses disclosed herein introduce air within the spray nozzle such that the air is capable of homogenizing the plural component mixture, the air is capable of aerating the homogenous mixture, and the air is capable of accelerating the aerated, homogenous mixture to a velocity suitable for spraying. The systems, methods, and apparatuses disclosed herein are able to produce a plural component material with superior foam characteristics, such as improved cell homogeneity, reduced cell size, reduced presence of voids in the cell structure, etc., over existing systems, methods, and apparatuses for producing foam. The systems, methods, and apparatuses disclosed herein are further able to produce high-quality foams at lower cost than existing systems, methods, and apparatuses.

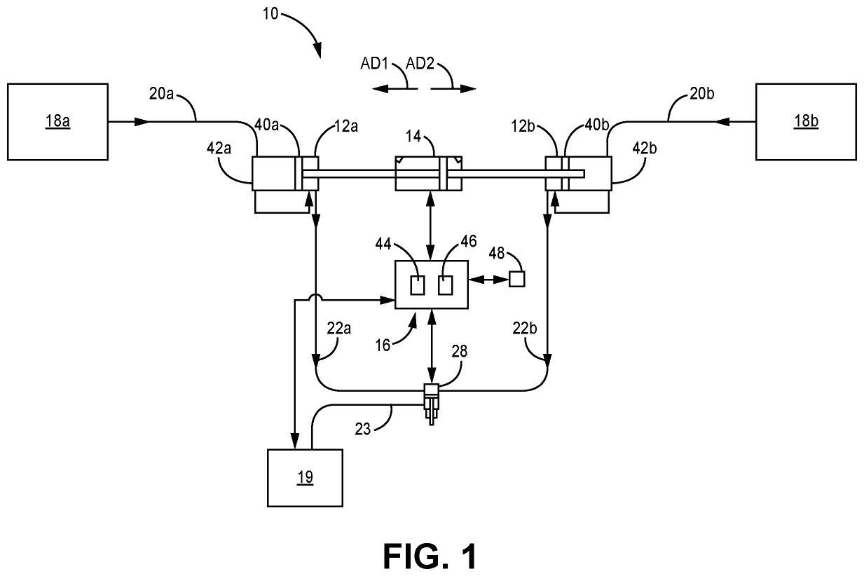

FIG. 1 is a schematic diagram of plural component dispense system 10. Plural component dispense system 10 includes material pumps 12a, 12b; pump drive 14; controller 16; material supplies 18a, 18b; air source 19; feed lines 20a, 20b; output lines 22a, 22b; air line 23; and dispenser 28. Controller 16 includes memory 44, control circuitry 46, and user interface 48.

System 10 is a plural component dispensing system configured to combine constituent components to form a resultant plural component material. While foam is used herein as an exemplar, it is understood that the resultant plural component can be an insulator, such as foam, or can be paint, sealant, coating, adhesive, etc. In some examples, system 10 is configured to combine a first component material, such as a resin (e.g., polyol resin), and a second component material, such as a catalyst (e.g., isocyanate), that combine to form a spray foam. While system 10 is shown and described as a system that combines two component materials to form the plural component material, it is understood that system 10 can be configured to combine more than two component materials to form the plural component material.

Material supplies 18a, 18b store the individual component materials. For example, each material supply 18a, 18b can be formed as a tank, drum, etc. Material pumps 12a, 12b receive the component materials respectively from material supplies 18a, 18b respectively through feed lines 20a, 20b and pump the component materials downstream respectively through output lines 22a, 22b. Each output line 22a, 22b connects to dispenser 28, discussed in more detail subsequently. In the example shown, material pumps 12a, 12b are disposed to receive the first and second component materials from material supplies 18a, 18b, respectively. Feed lines 20a, 20b respectively extend to material pumps 12a, 12b from material supplies 18a, 18b. Output lines 22a, 22b extend downstream from material pumps 12a, 12b, respectively, to dispenser 28.

The material pumps 12a, 12b pressurize the component materials and drive the component materials through output lines 22a, 22b. In some examples, the component materials are pressurized to an upstream pressure level greater than ambient prior to being received by material pumps 12a, 12b. The material pumps 12a, 12b then increase the pressures of the component materials to a downstream pressure level greater than the upstream pressure level and drive the component materials downstream through the output lines 22a, 22b according to the downstream pressure level. For example, the material supplies 18a, 18b can be pressurized tanks that output the pressurized component materials or system 10 can include upstream pumps that draw the component materials from the material supplies 18a, 18b and drive the component materials through the feed lines 20a, 20b and to the material pumps 12a, 12b, among other options. Such upstream pumps can also be referred to as transfer pumps. Material pumps 12a, 12b can also be referred to as metering pumps because material pumps 12a, 12b output the component materials at a metered flow rate to generate a desired mix at dispenser 28. Output lines 22a, 22b can also each include one or more valves for controlling the flow of each component material to dispenser 28.

In the example shown, material pumps 12a, 12b are linked for simultaneous reciprocation. Linking material pumps 12a, 12b for simultaneous reciprocation causes pumps to output the component materials according to a desired ratio for mixing and generating the plural component material. More specifically, material pumps 12a, 12b are connected to pump drive 14 to be reciprocated by pump drive 14. Material pumps 12a, 12b and pump drive 14 can be considered to form a pump assembly of the system 10. The material pumps 12a, 12b respectively include fluid displacers 40a, 40b, such as pistons or diaphragms, among other options, that are reciprocated to pump the component materials. Pump drive 14 can be of any desired configuration suitable for driving reciprocation of the fluid displacers 40a, 40b. For example, pump drive 14 can be an electric motor, pneumatically drive, hydraulically drive, etc. Controller 16 is operatively connected, electrically and/or communicatively, to pump drive 14 to control the speeds of material pumps 12a, 12b. For example, controller 16 can be operatively connected to a motor controller of the electric motor or to a fluid supply configured to route driving fluid (e.g., compressed air or hydraulic oil) to drive linear displacement, etc.

In the example shown, material pumps 12a, 12b are configured as piston pumps such that fluid displacers 40a, 40b are formed as pistons that reciprocate within cylinders 42a, 42b, respectively. In the example shown, material pumps 12a, 12b are configured as double displacement pumps that output the component materials during both a stroke in a first axial direction AD1 and a stroke in an opposite, second axial direction AD2.

Air source 19 is a source of air for creating an aerated mixture, such as a foam, at dispenser 28. Air line 23 fluidly connects air source 19 to dispenser 28. The air supplied by air line 23 can be pressurized air, such that the air provided via air line 23 can be used to create a plural component foam at dispenser 28. The air provided by air line 23 can also be used to accelerate and fluid at dispenser 28 to create a spray. Air source 19 can be a source of pressurized air, such that a pump is not required for air to flow from air source 19, through air line 23 and to dispenser 28. Additionally and/or alternatively, one or more pumps and/or compressors can be disposed in air source 19 or along air line 23 to pressure air flowing to dispenser 28. For example, air source 19 can be a pressurized tank or an air compressor, among other options.

Dispenser 28 is configured to receive the multiple component materials and the air, and to further mix the component materials with the air to form the plural component material. The plural component material formed by dispenser 28 can be, for example, a plural component foam. Dispenser 28 can be of any desired configuration for applying the multiple component material. In some examples, dispenser 28 can be an automatic dispenser configured to dispense the plural component material, such as a dispenser 28 mounted on a serial robot arm or other type of position manipulator. In some examples, dispenser 28 can be a handheld dispenser configured to dispense the plural component material, such that a user grasps and manipulates dispenser 28 to cause emission of the plural component material.

Controller 16 is operatively connected, electrically and/or communicatively, to other components of system 10. In the example shown, controller 16 is operatively connected at least to pump drive 14, air source 19, and dispenser 28, among other components. It is understood, however, that not all examples are so limited. For example, the controller 16 may not be connected to dispenser 28 with dispenser 28 formed as a handheld dispenser. In some examples, controller 16 may not be connected to air source 19 and air source 19 can be configured to continuously provide compressed air to dispenser 28. In other examples, air source 19 can be configured to deliver another gas suitable for use at dispenser 28. For example, air source 19 can be a source of another compressed gas suitable for introducing gas into materials received at dispenser 28.

Controller 16 is configured to control operation of one or more of the various components, provide operating instructions to one or more of the various components, and/or receive information from one or more of the various components. Controller 16 is configured to store software, implement functionality, and/or process instructions. The controller 16 can include memory 44 and control circuitry 46 configured to implement functionality and/or process instructions. For example, the control circuitry 46 can be capable of processing instructions stored in the memory 44. Examples of the control circuitry 46 can include one or more of a processor, a microprocessor, a controller, a digital signal processor (DSP), an application specific integrated circuit (ASIC), a field-programmable gate array (FPGA), or other equivalent discrete or integrated logic circuitry. The controller 16 can be of any suitable configuration for gathering data, processing data, etc. The controller 16 can receive inputs, provide outputs, generate commands for controlling operation of components of system 10, etc. The controller 16 can include hardware, firmware, and/or stored software. The controller 16 can be entirely or partially mounted on one or more circuit boards. The controller 16 can be configured to receive inputs and/or provide outputs via user interface 48.

User interface 48 can be any graphical and/or mechanical interface that enables user interaction with controller 16. For example, user interface 48 can implement a graphical user interface displayed at a display device of user interface 48 for presenting information to and/or receiving input from a user. User interface 48 can include graphical navigation and control elements, such as graphical buttons or other graphical control elements presented at the display device. User interface 48, in some examples, includes physical navigation and control elements, such as physically actuated buttons or other physical navigation and control elements. In general, user interface 48 can include any input and/or output devices and control elements that can enable user interaction with controller 16.

Memory 44 can be configured to store data and information before, during, and/or after operation. The memory 44, in some examples, is described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, the memory 44 is a temporary memory, meaning that a primary purpose of the memory 44 is not long-term storage. The memory 44, in some examples, is described as volatile memory, meaning that the memory 44 does not maintain stored contents when power to controller 16 is turned off. Examples of volatile memories can include random access memories (RAM), dynamic random access memories (DRAM), static random access memories (SRAM), and other forms of volatile memories. In some examples, the memory 44 is used to store program instructions for execution by the control circuitry 46. The memory 44, in one example, is used by software or applications running on controller 16 to temporarily store information during program execution. The memory 44, in some examples, also includes one or more computer-readable storage media. The memory 44 can be configured to store larger amounts of information than volatile memory. The memory 44 can further be configured for long-term storage of information. In some examples, the memory 44 includes non-volatile storage elements. Examples of such non-volatile storage elements can include magnetic hard discs, optical discs, flash memories, or forms of electrically programmable memories (EPROM) or electrically erasable and programmable (EEPROM) memories.

Controller 16 is operatively associated with material pumps 12a, 12b to control the material outputs of material pumps 12a, 12b. For example, controller 16 can provide a command to pump drive 14 to control the reciprocation speed of the fluid displacers 40a, 40b of material pumps 12a, 12b. Where system 10 includes one or more valves along output lines 22a, 22b, controller 16 can also be operatively connected to those valves to control their operation. Similarly, where system 10 includes one or more pumps at air source 19 or along air line 23, controller 16 can be operatively connected to those pumps to control their operation.

System 10 advantageously can dispense multiple different forms of plural component materials by feeding different component materials to system 10 and can create plural component foams by mixing air from air source 19 with different component materials. Notably, as air from air source 19 can be both used to create a plural component foam and to accelerate fluids within dispenser 28 for spraying the plural component foam, material pumps 12a, 12b can be configured to operate at lower pressures than pumps of systems that use the pressure of material flowing through output lines 22 to generate a spray. Similarly, mixing of air and the component materials can occur at relatively low pressures, meaning that system 10 does not require specialized components for mixing air with one or more high-pressure component materials. Further, as mixing of air and the plural component materials occurs at dispenser 28 rather than a point upstream of dispenser 28, system 10 does not require specialized components to are not required to aerate the component materials upstream of dispenser 28. In addition, air source 19 can provide compressed air both for mixing the plural component materials and for clearing out the nozzle of dispenser 28 when dispenser 28 is not emitting the plural component material. Accordingly, system 10 is less expensive and simpler than other systems for creating plural component materials.

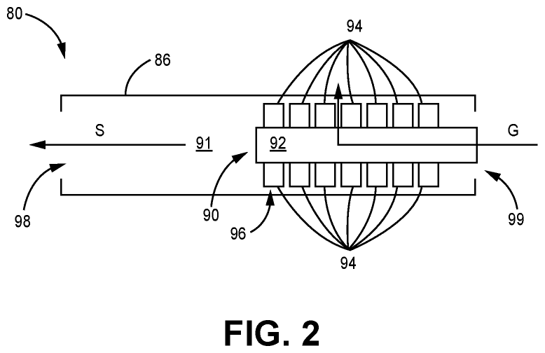

FIG. 2 is a schematic cross-sectional view of spray dispenser 80, which is one example of a dispenser that can be used to mix and dispense aerated plural component material in system 10 in place of dispenser 28 (FIG. 1). Spray dispenser 80 includes housing 86 and mixer 90. Housing 86 defines inner chamber 91, and mixer 90 is disposed within inner chamber 91. Mixer 90 is a static mixer configured to mix plural component materials and air. Mixer 90 is a static mixer such that mixer 90 does not translate or rotate during operation of spray dispenser 80. Mixer 90 includes shaft 92 and extensions 94, which extend from shaft 92. Extensions 94 function to mix plural component material and air flowing through inner chamber 91 and define mixing channel 96 for mixing component materials into a plural component material and further for mixing air into the plural component material to form an aerated plural component material. Mixing channel 96 is a turbulent flow path that causes mixing of components that flow through mixing channel 96. Housing 86 also defines spray outlet 98 and nozzle receiver 99. Spray outlet 98 is configured to spray or apply aerated plural component material and nozzle receiver 99 is configured to receive component materials of the plural component material and/or air for aerating the plural component material. In some examples, nozzle receiver 99 can also be configured to be received by another component of a spray dispenser.

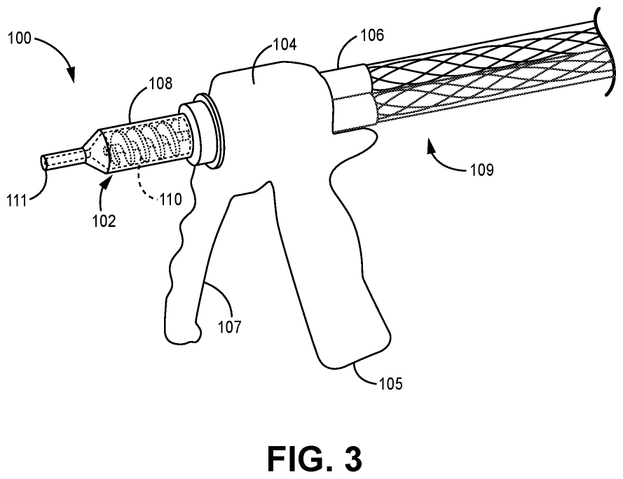

Shaft 92 defines gas flow path G, which flows air from an air source (e.g., air source 19; FIG. 1). In operation, a first component material and a second component material flow into inner chamber 91 via nozzle receiver 99. As described previously, extensions 94 define a turbulent flow path (i.e., mixing channel 96) that causes the first material and the second material to at least partially mix as they flow through mixing channel 96. Air is introduced to the plural component mixture at a point along mixing channel 96 according to gas flow path G. The air introduced into the plural component mixture aerates the plural component mixture and causes the plural component mixture to fully mix, if the plural component mixture is not homogenously or fully mixed prior to introduction of air. The aerated plural component mixture continues to flow through inner chamber 91 toward spray orifice 98 according to spray flow path S. The aerated plural component material is emitted from spray orifice 98 as a spray in the direction of spray flow path S. Extensions 94 are shown 14 as discrete components disposed adjacent to shaft 92 in FIG. 3 to define a turbulent mixing channel (i.e., mixing channel 96). In other examples, extension 94 can be any number of discrete components or can be a single, continuous component. In yet further examples, extensions 94 can be attached to shaft 92. In some examples, extensions 94 can be formed integrally with housing 86. Shaft 92 can be inserted into inner chamber 91 prior to operation of spray dispenser 80. Further, in other examples, extensions 94 be, e.g., fins or other suitable shapes, or can form a helix or double helix. Some extensions 94 can be differently shaped than others of extensions 94 The shape of extensions 94 can be selected to define the shape of mixing channel 96. In all examples, the components of mixer 90 cause mixer 90 to function as a static mixer when disposed in inner chamber 91. Each of extensions 94 can extend partially or fully around shaft 92 and can extend partially or fully from shaft 92 to an inner surface of housing 86.

FIG. 3 is a simplified isometric view of sprayer 100, which is an example of a plural component dispenser suitable for use as dispenser 28 (FIG. 1) in system 10 (FIG. 1). Sprayer 100 includes spray nozzle 102, sprayer housing 104, and fluid receiver 106. Spray nozzle 102 includes nozzle housing 108 and mixer 110. Housing 104 includes handle 105 and trigger 107. Fluid receiver 106 is connected to fluid lines 109.

Sprayer 100 is configured to receive multiple component materials and air, and further to create and spray a plural component foam. In the depicted example, sprayer 100 is a handheld foam sprayer operable by a human operator, but in other examples, sprayer 100 can be configured to be operated by a serial robot arm or other type of position manipulator. In some examples, sprayer 100 can be referred to as a spray gun or a dispenser.

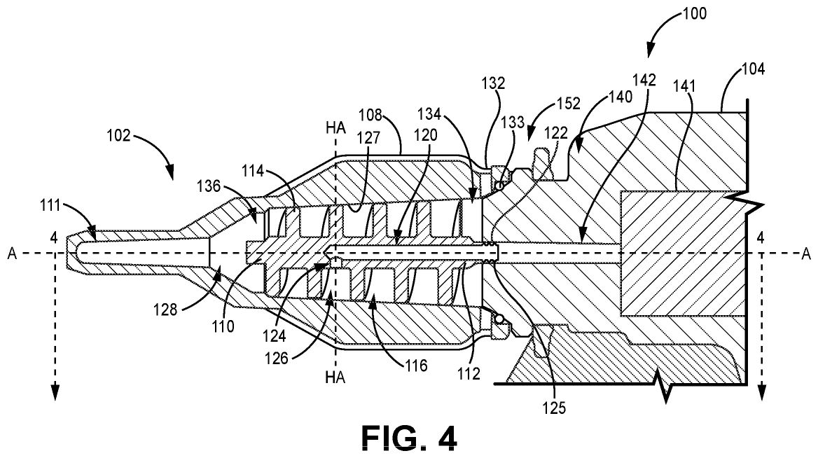

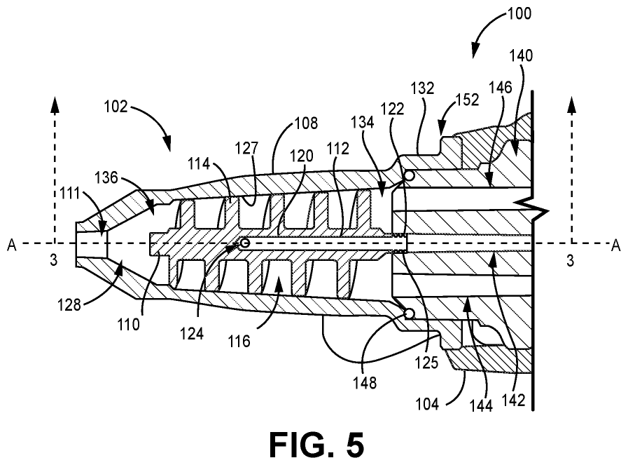

Spray nozzle 102 is a nozzle for creating and spraying a plural component foam. Spray nozzle 102 includes nozzle housing 108 and mixer 110, and spray orifice 111 is formed in the downstream tip of nozzle housing 108. As will be explained in more detail subsequently, and particularly with respect to FIGS. 4-5, nozzle housing 108 and mixer 110 create a helical channel for flowing and mixing component materials into a plural component foam. Sprayer housing 104 includes handle 105 and trigger 107. Handle 105 is sized and configured to allow a user to grasp handle 105 with a single hand, enabling the user to position and use sprayer 100 with a single hand. Handle 105 can be formed integrally with sprayer housing 104 or separately from sprayer housing 104 and connected thereto. Trigger 107 is movable relative to handle 105 and is operatively connected to one or more valves disposed within sprayer housing 104 and/or upstream of sprayer 100. A user can operate trigger 107 to actuate the valve(s) and cause sprayer 100 to generated and spray a plural component foam. Trigger 107 can be connected to the valve by, for example, one or more electrical and/or mechanical elements.

Fluid receiver 106 fluidly connects fluid lines 109 to one or more valve disposed inside sprayer housing 104 and/or spray nozzle 102. Fluid receiver 106 can be formed as a separate component connected to sprayer housing 104 or fluid receiver 106 can be formed as a portion of sprayer housing 104. Fluid receiver 106 can include one or more sealing elements to provide a seal between fluid lines 109 and sprayer 100. Fluid lines 109 can include one or more fluid lines for delivering fluids to sprayer 100. The fluids can be, for example, air or a component material of a plural component mixture, among other options. Accordingly, fluid lines 109 can be include one or more of output lines 22a, 22b or air line 23. In the example shown, fluid lines 109 include a set of three fluid lines, two for component materials and one for air, though it is understood that not all examples are so limited.

In operation, fluid receiver 106 receives component materials, such as two or more component materials, and those component materials are flowed through sprayer housing 104 to spray nozzle 102. The component materials enter the helical channel formed by mixer 110 and nozzle housing 108. Mixer 110 causes partial mixing of the component material materials into a heterogenous mixture. Fluid receiver 106 also receives air that is then flowed to spray nozzle 102. As will be explained in more detail subsequently, the air is introduced to the heterogenous material mixture at a mix point to assist in mixing and creation of a homogeneous plural component mixture. The homogenous plural component mixture flows from within nozzle 102 to spray orifice 111 which is formed in the tip of spray nozzle 102 and from which the mixture is sprayed as a plural component foam.

FIGS. 4 and 5 are cross-sectional views of portions of sprayer 100 and will be discussed together. The views in FIGS. 4 and 5 are both taken along axis A-A and are offset 900 about axis A-A, such that the cross-sectional planes of the views shown in FIGS. 4 and 5 are orthogonal. More specifically, FIG. 4 is taken along line 3-3 of FIG. 5 and FIG. 5 is taken along line 4-4 of FIG. 4. As shown in FIGS. 4 and 5, sprayer 100 includes spray nozzle 102 and sprayer housing 104. Spray nozzle 102 is similar to dispensing nozzle 80 (FIG. 2) includes spray nozzle housing 108 and mixer 110. Mixer 110 is substantially similar to mixer 90 (FIG. 2) and includes shaft 112, extension 114, and mixing channel 116, inner air channel 120, air inlet 122, air outlet 124, and shaft seal 125. Shaft 112 is substantially similar to shaft 92 and extension 114 is substantially similar to extensions 94 (FIG. 2). The location of air outlet 124 defines mix point 126. Spray nozzle housing 108 is substantially similar to housing 86 and includes spray nozzle orifice 111, inner housing surface 127, inner chamber 128, nozzle receiver 132, and seal 133. Spray nozzle orifice 111 is substantially similar to spray orifice 98, inner chamber 128 is substantially similar to inner chamber 91, and nozzle receiver 132 is substantially similar to nozzle receiver 99 (FIG. 2). Mixing channel 116 is substantially similar to mixing channel 96 and includes upstream channel end 134 and downstream channel end 136. Sprayer housing 104 includes path housing 140, valve 141, air path 142, first material path 144, second material path 146, and connection interface 152. Axis line A-A is shown as a continuous line in FIG. 4 and is shown as a partial line in FIG. 5 to allow the position of air outlet 124 along inner air channel 120 to be clearly shown.

As will be explained in more detail, spray nozzle 102 is configured to initially create a heterogenous mixture of multiple component material materials, such that the components have a non-uniform distribution in the mixture. Spray nozzle 102 introduces air to the heterogenous mixture at mix point 126 to create a homogenous plural component mixture, such as foam. More specifically, the air introduced at mix point 126 is nucleation air, in that the air both nucleates and provides air to form foam cells in the plural component mixture. The air introduced at the mix point 126 also functions to accelerate the flow of the plural component foam to create a spray when passed through nozzle orifice 111 of spray nozzle 102.

Spray nozzle housing 108 is generally cylindrical and extends along axis A-A. Spray nozzle housing 108 is a hollow structure, such that inner housing surface 127 of spray nozzle housing 108 defines inner chamber 128, which is a flow space through which fluids can flow. In at least some examples, spray nozzle housing 108 can be referred to as an “outer tube” and inner chamber 128 is referred to as “mixing chamber.” Mixer 110 is disposed within inner chamber 128, and functions as a static mixer within inner chamber 128. Mixer 110 is a static mixer such that, during operation, mixer 110 does not translate along or rotate on axis A-A. In some examples, mixer 110 may be referred to as an auger, but it is understood that mixer 110 is static and does not move during operation. The static position of mixer 110 allows mixer 110 to define a static mixing channel 116 for mixing of component materials and air prior to spraying through nozzle orifice 111.

Mixer 110 includes shaft 112 and extension 114. Shaft 112 extends along axis A-A and extension 114 extends away from shaft 112 in a direction generally perpendicular to axis A-A. In at least some examples, shaft 112 can be referred to as an “inner tube.” Extension 114 can be considered to extend radially outward from shaft 112 away from axis A-A. Shaft 112 is elongate along axis A-A. Shaft 112 can be cylindrical and can extend coaxially with the axis A-A. In the example shown, extension 114 forms a helix that wraps around and along shaft 112, such that shaft 112 is parallel with and overlaps the screw axis of extension 114. It is understood that extension 114 can be formed in any desired manner suitable for causing mixing between the multiple component materials flowing through mixing channel 116. For example, extension 114 can be formed as a single helix, a double helix, one or more projections or fins, among other options. The screw axis of extension 114 is coaxial with axis A-A in the depicted example. As both extension 114 and shaft 112 are coaxial with axis A-A in the example shown in FIGS. 4-5, mixer 110 can be described as coaxial with axis A-A in the depicted configuration. In other examples, one of shaft 112 and extension 114 can be coaxial with axis A-A and the other of shaft 112 and extension 114 can extend in a manner that is not coaxial with and/or not parallel with axis A-A. In yet further examples, both shaft 112 and extension 114 can extend such that both shaft 112 and extension 114 are not coaxial with axis A-A. Shaft 112 and extension 114 can each also extend such that shaft 112 and/or extension 114 are not parallel with axis A-A. Extension 114 extends from shaft 112 to inner housing surface 127 along the length of shaft 112 to define mixing channel 116 between the spaces formed by adjacent turns of extension 114, shaft 112, and inner housing surface 127.

Mixing channel 116 is a flow path formed within inner chamber 128 and is defined by extension 114, inner housing surface 127, and shaft 112. Material flowing through the flow path of mixing channel 116 flows past extension 114, which causes mixing of plural component materials. Mixing channel 116 can be formed as a helical flow path, among other options. In the example shown, mixing channel 116 is configured such that the materials swirl around shaft 112 as the materials flow through mixing channel 116. In the depicted example, mixing channel 116 allows for heterogenous mixing of component materials upstream of mix point 126 and homogenous mixing of air and component materials into a homogenized plural component foam downstream of mix point 126. Mixer 110 does not extend through the entirety of inner chamber 128, such that mixer 110 separates inner chamber 128 into two volumes: the first volume is mixing channel 116, and the second volume is the downstream portion of inner chamber 128 (i.e., downstream of extension 114) through which fluid flows to nozzle orifice 111. Upstream channel end 134 and downstream channel end 136 define the upstream and downstream ends, respectively, of mixing channel 116. Upstream channel end 134 receives fluids from air path 142, first material path 144, and second material path 146. Downstream channel end 136 communicates fluids to the downstream portion of inner chamber 128 (i.e., the second volume discussed previously) and to nozzle orifice 111. In this manner, fluids flow through spray nozzle 102 in a similar manner gas flow path G, spray flow path S, and the other flow paths of spray dispenser 80 (FIG. 2).

Mix point 126 is the location within mixing channel 116 where air is emitted from mixer 110 to mix with the component materials flowing through the mixing channel 116. In operation, the component materials upstream of mix point 126 are partially incorporated into a heterogenous mixture. Air from air outlet 124 is blown into the heterogenous mixture at mix point 126, and the combination of air from air outlet 124 and the remaining helical turns of mixing channel 116 causes the component materials to fully mix into an aerated plural component mixture. The aerated plural component mixture can then be sprayed through nozzle orifice 111 to form the plural component foam mixture. Mix point 126 is located adjacent to the location of air outlet 124 in mixing channel 116, such that adjusting the location of air outlet 124 along mixer 110 also adjusts the location of mix point 126 along mixing channel 116.

Inner air channel 120 extends through shaft 112 from air inlet 122 to air outlet 124 and is defined by an inner surface of shaft 112. Inner air channel 120 extends along axis A-A and is configured to deliver air through shaft 112 to mix point 126. Inner air channel 120 does not extend fully axially through mixer 110, in the example shown. Inner air channel 120 extends to radially overlap with only a subset of the fins forming extension 114. Components can be considered to radially overlap when the components are disposed at a common location along axis A-A such that a radial line extending from axis A-A passes through each of those radially overlapping components. Such a configuration facilitates additional passes within helical chamber of the material after air injection, enhancing mixing and providing a high-quality plural component mixture. The air flow path defined by inner air channel 120, air inlet 122, and air outlet 124 is substantially similar to gas flow path G described previously with respect to FIG. 2.

Air inlet 122 is an orifice formed in one end of shaft 112 and is configured to accept a flow of air. The hole axis of air inlet 122 is coaxial on axis A-A in the depicted example, though in other examples air inlet 122 can be repositioned to accept a flow of air at a different location. Air outlet 124 is an orifice disposed partially along the axial length of shaft 112 from air inlet 122 and that emits a flow of air to mix point 126. Hole axis HA-HA of air outlet 124 is offset from axis A-A. Hole axis HA-HA can be transverse to axis A-A. In some examples, hole axis HA-HA of air outlet 124 can be orthogonal to axis A-A, parallel to axis A-A, or coaxial with axis A-A. Where the hole axis HA-HA of air outlet 124 is parallel to or coaxial with axis A-A, air outlet 124 can be disposed in the axially downstream end of shaft 112. For example, air outlet 124 can be formed as an orifice on the axially-opposite end of shaft 112 from air inlet 122. In the example depicted in FIG. 4, however, air outlet 124 is disposed in a circumferentially-outer surface of shaft 112. More specifically, air outlet 124 is disposed proximate a midpoint along mixer 110. Advantageously, the depicted configuration allows for improved mixing and aeration of plural component material flowing through inner chamber 128.

Nozzle orifice 111 is formed in one end of spray nozzle housing 108 and emits plural component foam formed within spray nozzle 102 as a spray. Nozzle orifice 111 is positioned in the depicted example such that the hole axis of nozzle orifice 111 is coaxial with axis A-A. Advantageously, this positioning of nozzle orifice 111 can improve the ease with which a human operator can aim spray nozzle 102 to apply a plural component foam created within spray nozzle 102, but in other examples nozzle orifice 111 can be formed in other locations of spray nozzle housing 108.

Nozzle receiver 132 is formed in the end of spray nozzle housing 108 opposite nozzle orifice 111 and is configured to interface with a portion of path housing 140. In the example shown, nozzle receiver 132 receives the portion of path housing 140, though it is understood that not all examples are so limited. In the depicted example, path housing 140 is formed as a portion of sprayer housing 104. Spray nozzle 102 can be removably attached to sprayer housing 104 via the interface between nozzle receiver 132 and path housing 140. Nozzle receiver 132 defines an upstream end of spray nozzle 102 and nozzle orifice 111 defines a downstream end of spray nozzle 102, such that fluids flowing through spray nozzle 102 flow toward nozzle orifice 111 generally axially along axis A-A. In the depicted example, the axially-downstream end of path housing 140 extends partially beyond the axially-upstream end of sprayer housing 104. Nozzle receiver 132 is formed as a shoulder that circumferentially surrounds the exposed downstream end of path housing 140. The axially-upstream end of nozzle receiver 132 is spaced from the axially the axially-downstream end of sprayer housing 104 in FIG. 4, but in other examples the axially-upstream end of nozzle receiver 132 can abut the axially-downstream end of sprayer housing 104.

Path housing 140 receives fluids, such as component materials or air, from fluid receiver 106 (FIG. 3), via sprayer housing 104 and valve 141, and delivers those fluids to the interior space of spray nozzle 102 defined by inner housing surface 127. Path housing 140 defines internal paths, described in more detail subsequently, to deliver received fluids to mixing channel 116 and/or air channel 120. In at least some examples, the paths defined by path housing 140 can be referred to as “outlets” for materials and/or air. Valve 141 controls flow of fluids from fluid receiver 106 to path housing 140. Valve 141 is operatively connected to trigger 107 such that trigger 107 can be used to actuate valve 141 (e.g., between a closed state and an open state). In the depicted example, valve 141 is a sliding valve, but in other examples valve 141 can by another suitable type of valve for selectively permitting flow of fluids from fluid receiver 106 to path housing 140.

Path housing 140 includes air path 142, first material path 144, and second material path 146. Air path 142 is fluidly connected to air line 23 via fluid receiver 106 and valve 141, and first and second material paths 144 and 146 are connected to output lines 22a and 22b, respectively, via fluid receiver 106 and valve 141. Path housing 140, valve 141, and fluid receiver 106 are structured to keep the component materials separate upstream of inner chamber 128 defined by inner housing surface 127, and further to keep air separate from either component material upstream of mix point 126.

In operation, first and second materials from material supplies 18a, 18b flow through first material path 144 and second material path 146 into inner chamber 128 and through mixing channel 116. Flowing the first material and second material through mixing channel 116 causes the first and second materials to partially incorporate into a heterogenous mixture that can have a non-uniform distribution of the first and second materials. The first and second materials flow from the upstream end to air inlet 122, where they are mixed and aerated, as described in more detail subsequently. The relative volume of each of the first and second materials in the heterogenous mixture is selected based on the desired final ratio of the first and second materials in the sprayed plural component foam. Nozzle housing 108 is fluidically sealed from nozzle receiver 132 to nozzle orifice 111, such that fluid does not pass through (i.e., into or out of) nozzle housing 108 at a point along nozzle housing 108 other than at nozzle receiver 132 and/or nozzle orifice 111.

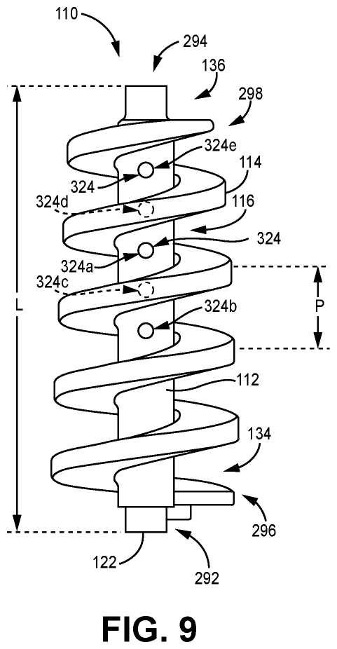

Air flows through air path 142 into air inlet 122, through air channel 120, and into mixing channel 116 through air outlet 124. Air flowing through air outlet 124 aerates the heterogenous mixture flowing through mixing channel 116 and causes the heterogenous mixture to further mix into a homogenous mixture. The air flowing through air outlet 124 can also increase the velocity of the first and second materials, such that the fluid downstream of mix point 126 flows at a higher velocity than fluid upstream of mix point 126. As will be explained in more detail subsequently, and particularly with respect to FIG. 9, the location of mix point 126 can be selected by adjusting the position of air outlet 124 along shaft 112. Positioning air outlet 124 too far upstream or downstream along shaft 112 can cause spray nozzle 102 to spray foam having undesirable characteristics, such as nonuniform cell distribution or large cell sizes. The aerated, homogenous plural component mixture flows from mix point 126 to downstream channel end 136 of mixing channel 116 and out of mixing channel 116 through the portion of inner chamber 128 defined by inner housing surface 127 downstream of mixer 110 and to nozzle orifice 111. The aerated, homogenous plural component material is then emitted as a spray through nozzle orifice 111.

Mixer 110 is fluidically sealed from air inlet 122 to air outlet 124, such that fluid does not pass through mixer 110, extension 114, and/or shaft 112 other than at air inlet 122 and/or air outlet 124. Mixer 110 advantageously introduces air into materials flowing through inner chamber 128 within nozzle 102 rather than a point upstream of nozzle 102. This configuration allows the air introduced within nozzle 102 to aid in mixing of components of the heterogenous component mixture into a homogenous component mixture while simultaneously aerating that mixture into an aerated plural component material.

In the depicted example, air is only introduced to inner chamber 128 at mix point 126, which is located along mixing channel 116. Air is not introduced to mixing channel 116 or any location of inner chamber 128 other than at mix point 126. Air is not introduced to any of the materials upstream of mixer 110 and air is also not introduced downstream of mixer 110. More specifically, mixer 110 and spray nozzle 102 are configured such that air is not introduced at an upstream or downstream location of mixer 110 when sprayer 100 is operating in a steady state. As used herein, a “steady state” refers to a continuous operation of sprayer 100 to spray aerated plural component material with a constant or substantially constant flow rate of emitted aerated plural component material.

In the example shown, mixer 110 includes only one air outlet 124, such that there is not more than one air outlet along mixer 110 and, accordingly, there is not more than one mix point 126 along mixing channel 116. Of the components of nozzle 102, air path 142 is only fluidly connected to air inlet 124, such that air does not flow from air path 142 to any point or location of inner chamber 128 except at mix point 126.

As nozzle housing 108 is also fluidically sealed, air is not introduced to inner chamber 128 by an air source other than the air provided by air path 142. Air is not introduced by, for example, flowing air from a point external to nozzle housing 108 and across or through nozzle housing 108 to a point internal to nozzle housing 108 (i.e., a point within inner chamber 128). Nozzle 102 does not include an air path for introducing air through, for example, nozzle orifice 111 and further does not include any additional apertures along nozzle housing 108 for introducing air to inner chamber 128. Accordingly, all aeration of the materials introduced into inner chamber 128 occurs by the introduction of air through air outlet 124. Advantageously, introducing air along mixing channel 116 allows air to be used in combination with mixer 110 to mix the heterogenous plural component mixture into a homogenous plural component mixture. Mixer 110 can, in some examples, include multiple air outlets 124, but introducing air at a single air outlet 124 can produce aerated plural component material having improved material characteristics as compared to embodiments having multiple air outlets 124 along mixer 110. Similarly, as described previously, using a single circumferentially-disposed air outlet 126 rather than a single axially-disposed air outlet 126 also improves the foam quality of aerated plural component material produced using nozzle 102. Some examples of mixer 110 do not include more than one air outlet 124. Extension 114 is generally shown and described herein as having a helical geometry, such that extension 114 forms a helix about shaft 112 having a helical axis that is coaxial with the axis of shaft 112. However, in other examples, extension 114 can adopt other geometries suitable for a static mixer configured to form a heterogenous mixture from a flow of component materials. For example, extension 114 can be formed as one or more discrete extensions projecting from shaft 112. Mixer 110 can include multiple extensions 114 extending from shaft 112 with a distance therebetween that does not include an extension 114. The air outlet 124 can be disposed along one of the multiple extensions 114 or in the axial gap therebetween. Some examples can include extension 114 formed by multiple projections. Some examples of the projections can wrap partially or fully around the shaft 112. Some examples of the projections do not wrap around shaft 112. In some examples the projections forming extension 114 can be formed by multiple discrete posts or fins extending from shaft 112.

Mixer 110 is discussed and shown herein as being a single, continuous component that acts as a static mixer in inner chamber 128. It is understood, however, that mixer 110 can be formed of multiple components. For example, shaft 112 and extension 114 can be formed as separate components that can be arranged to define mixing channel 116 for mixing material components. Similarly, any of shaft 112, extension 114, and/or another element of mixer 110 can be formed as multiple discrete or separate components that, in combination, function as a static mixer when disposed in inner chamber 128. In all examples, mixer 110 defines air channel 120, air inlet 122, and air outlet 124. In some examples, extension 114 can be formed integrally with nozzle housing 108 with shaft 112 formed separately from extension 114 and inserted into extension 114 during mounting of nozzle 102.

In the depicted example, extension 114 has a helical geometry, though it is understood that not all examples are so limited. The helical geometry (e.g., pitch, diameter, etc.) of extension 114 is selected such that mixing channel 116 causes the first and second materials to form a heterogenous mixture, such that the first material and second material have a non-uniform distribution throughout the heterogenous mixture. Partially incorporating the first and second materials into a heterogenous mixture can improve foam characteristics (e.g., cell distribution uniformity, cell size, etc.) of the plural component foam created from the mixture and the air introduced at mix point 126. The flow rates of the first and second materials flowing into mixing channel 116 are selected according to the desired final ratio of the component materials of the plural component foam. The partial incorporation by mixing channel 116 helps to create uniform ratios of the component materials in the heterogenous mixture upstream of mix point 126 by reducing aggregation of individual component materials. Further, the continuous change in flow direction imparted by mixing channel 116 can create uniform ratios even of components having differing viscosities. Advantageously, this creating a uniform ratio of component materials upstream of mix point 126 maintains the correct ratio of the component materials at mix point 126 and while the component materials are not fully incorporated into a homogenous mixture.

As depicted in FIGS. 4 and 5, inner housing wall 118 tapers as inner housing wall 118 extends in a downstream direction, such that the diameter of inner housing wall 118 at points along axis A-A decreases in a downstream direction. In the depicted example, the helical diameter of extension 114 of mixer 110 also decreases in a downstream direction. Advantageously, this can improve the fit of mixer 110 against inner housing wall 118 and reduce the likelihood that fluid can migrate axially downstream and across turns of extension 114 rather than flow through mixing channel 116 defined by extension 114. Axial fluid migration can reduce the uniformity of the ratios of the component materials in the heterogenous mixture upstream of mix point 126, especially in examples where the component materials have differing viscosities. Accordingly, the improved fit provided by the tapered shapes of inner housing wall 118 and extension 114 can improve the quality of the foam sprayed by spray nozzle 102.

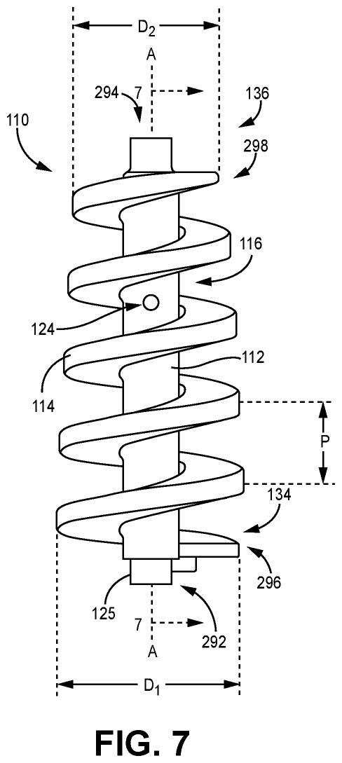

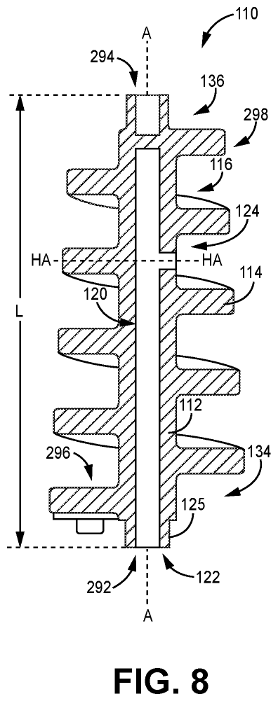

Mixer 110 and/or spray nozzle housing 108 can be formed by, for example, machining, molding, additive manufacturing, or any other suitable technique or combination thereof. For example, mixer 110, including air channel 120, air inlet 122, and air outlet 114, can be formed by molding polymer materials. Spray nozzle housing 108 can be separately formed by molding and spray nozzle 102 can be assembled by inserting mixer 110 into the space defined by inner housing surface 127. In some examples, the outer circumference of extension 114 can be attached and/or joined to inner housing surface 127 by, e.g., welding. Alternatively, extension 114 and/or the entirety of mixer 110 can be formed integrally with nozzle housing 108, such that mixer 110 and nozzle housing 108 form a monolithic structure. In yet further examples, the helical diameter(s) of extension 114 (described in more detail with respect to FIGS. 7-8) can be selected to be slightly larger than the diameter of the corresponding points of inner housing surface 127 when mixer 110 is installed, such that mixer 110 is held within spray nozzle housing 108 by an interference or press fit. Inner housing surface 127 and mixer 110 can both be axially-tapered to improve the ease with which mixer 110 can be installed in a press or interference fit arrangement inside spray nozzle housing 108. Where mixer 110 and inner housing surface 127 are formed of polymer materials, the outer circumference of extension 114 can be joined to inner housing surface 127 by ultrasonic welding. In other examples, spray nozzle housing 108 and mixer 110 can be formed as a monolithic component by, for example, an additive manufacturing technique.

In the depicted example, nozzle receiver 132 is sealed against path housing 140 with seal 133 and air inlet 122 is sealed against air path 142 by shaft seal 125. Seal 133 is a separate seal element that reduces or prevents reverse flow through the interface between path housing 140 and nozzle receiver 132. Seal 133 is an O-ring in the depicted example, but in other examples seal 133 can be crush seal or any other suitable type of seal for creating a seal between nozzle receiver 132 and path housing 140. In yet further examples, seal 133 can be formed integrally with nozzle receiver 132 and/or path housing 140.

Shaft seal 125 is formed at the upstream end of shaft 112 that prevents flow of air into mixing channel 116 ahead of mix point 126. In the example shown, shaft seal 125 is integrally formed with shaft 112 and projects from shaft 112. Shaft seal 125 is depicted as several ribs that each extend radially from shaft 112 and that are spaced axially along shaft 112. The ribs can be deformable and/or compressible to create a circumferential seal between air inlet 122 and air path 142, such that no air flow through air path 142 flows around air inlet 122 and into the inner chamber 128 of nozzle 102 (e.g., helical fluid path 116) upstream of mix point 126. In other examples, shaft seal 125 can additionally and/or alternatively include one or more of O-rings, one or more crush seals, and/or one or more other suitable sealing elements.

The upstream end of nozzle receiver 132 is affixed to sprayer housing 104 at connection interface 152. Connection interface 152 enables spray nozzle 102 to be removably attachable to sprayer housing 104 and is configured to cause seal 133 and shaft seal 125 to engage and form seals against path housing 140 when connection interface 152 is fully formed between spray nozzle 102 and sprayer housing 104. In the depicted example, connection interface 152 is formed as a locking bayonet type connection, but in other examples, the upstream end of nozzle receiver 132 can be affixed to sprayer housing 104 with any suitable reversible connection to enable removable attachment of spray nozzle 102 to sprayer housing 104. For example, nozzle receiver 132 can be removably affixed to spray gun housing 104 by a screw attachment or by using one or more clips. Advantageously, forming spray nozzle 102 and sprayer housing 104 so that spray nozzle 102 is removably attachable enables spray nozzle 102 to be exchanged during operation of sprayer 100 and/or plural component dispense system 10. For example, spray nozzle 102 can become clogged during operation due to plural component material curing inside of nozzle 102. Forming spray nozzle 102 as a detachable component of sprayer 100 allows a clogged spray nozzle 102 to be replaced with a new, unclogged spray nozzle 102 without requiring significant downtime of sprayer 100 and/or plural component dispense system 10. Forming spray nozzle 102 as a removably attachable part also allows spray nozzle 102 to be easily replaced after significant wear to spray nozzle 102. For example, where spray nozzle 102 is formed of an abradable material, such as a polymer material, nozzle orifice 111 can wear overtime and deform. Deformation of nozzle orifice 111 can affect the quality of spray (e.g., droplet size, spray flow rate, etc.) produced by 102. In examples where spray nozzle 102 is a replaceable part, a deformed, worn spray nozzle 102 can be replaced by a new spray nozzle 102 to avoid spraying plural component foams with a suboptimal spray quality.

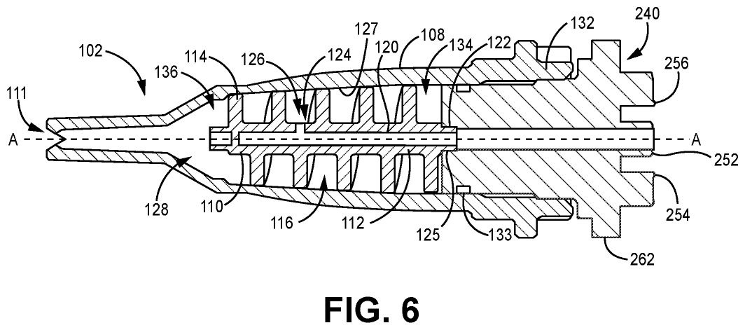

In other examples, the path housing 140 can be integrated into spray nozzle 102, such that removing spray nozzle 102 also removes the path housing 140 from sprayer 100. FIG. 6 is an example of spray nozzle 102 including removable path housing 240. Removable path housing 240 includes air channel 252, first material channel 254, second material channel 256, seal 248, and connector 262. Removable path housing 240 is substantially similar to path housing 140, except that removable path housing 240 is formed separately from sprayer body 104 and is removable from sprayer body 104. FIG. 6 also depicts spray nozzle 102, spray nozzle housing 108, mixer 110, nozzle orifice 111, shaft 112, extension 114, mixing channel 116, inner air channel 120, air inlet 122, air outlet 124, mix point 126, inner housing surface 127, nozzle receiver 132, and seal 133. For illustrative and explanatory clarity, other components of sprayer 100 (e.g., valve 141, nozzle receiver 132, etc.) are not shown in FIG. 6.

Path housing 240 is substantially similar to path housing 140 discussed previously with respect to FIGS. 4 and 5, but is affixed to nozzle receiver 132 such that path housing 240 can be easily removed from sprayer 100 with other components of spray nozzle 102. More specifically, in FIG. 6, nozzle receiver 132 circumferentially surrounds a portion of path housing 240 rather than an integral path housing of sprayer 100 and nozzle receiver 132 axially (i.e., along axis A-A) abuts the axially-upstream side of path housing connector 262. Air channel 252, first material channel 254, and second material channel 256 are substantially similar to air path 142, first material path 144, and second material path 146, respectively, and the discussion of those components is applicable to air channel 252, first material channel 254, and second material channel 256. Connector 262 is configured to interface with a spray gun, such as sprayer 100, and can include one or more attachment mechanisms (e.g., bayonet or screw attachments, etc.) and/or one or more seals (e.g., O-rings, crush seals, sealing ribs, etc.). Path housing 240 can interface with path housing 140 or another component of sprayer 100 by nozzle receiver 132. In some examples, having a separate path housing (such as path housing 240) attached to nozzle 102 can allow for sprayer 100 to adopt a simpler design that does not include the integrated valve and path housing components depicted in FIGS. 4 and 5.

Spray nozzle 102 provides a number of advantages over existing spray nozzles. Spray nozzle 102 allows for component materials to incorporate before air is added. Incorporating the component materials into a heterogenous mixture before mixing the component materials into a plural component foam can improve the characteristics (e.g., cell uniformity, cell size, etc.) of that foam. Further, where the component materials have different viscosities, the heterogenous mixture formed by mixing channel 116 can ensure that the materials are in the correct ratio at mix point 126. Where non-helical channels or no channel is used (i.e., where air is introduced immediately after path housings 140, 240), the less viscous component material can flow past the more viscous component material, leading to spray foam having undesirable foam characteristics.

Spray nozzle 102 also allows for foams to be created from lower pressure component materials and lower pressure air than existing designs. As the air introduced at air outlet 124 is used to accelerate the plural component foam to a suitable velocity for spraying by nozzle orifice 111, pumps and connecting components delivering the component materials (e.g., material pumps 12a, 12b, output lines 22a, 22b, etc.) are not required to create and deliver high pressure materials to sprayer 100. Further, as air is introduced in spray nozzle 102 to a heterogenous mixture of component materials shortly before spraying through nozzle orifice 111, the air delivered to air inlet 122 can be at a relatively low pressure. In some examples, an air pressure of 40 pounds per square inch (psi) (about 0.276 megapascal (MPa)) can be sufficient to foam and mix the heterogenous mixture into a homogenous plural component foam and further to provide energy for spraying the foam through nozzle orifice 111. Accordingly, specialized equipment required to create high-pressure air is not required to operate spray guns having spray nozzle 102. Sprayer 100 is likewise not required to have components capable of tolerating relatively high component material pressures or air pressures. Spray nozzle 102, then, can reduce costs associated with producing high-pressure foams as compared to existing systems, which often use expensive and specialized high-pressure components. Notably, spray nozzle 102 is also compatible of using high-pressure material and air flows to create high-quality plural component foams having desirable foam characteristics (e.g., uniform and small cell sizes, etc.). Advantageously, this allows spray nozzle 102 to also be integrated into existing high-pressure systems to improve the quality of foam created using those systems.

FIG. 7 is a plan view of mixer 110. FIG. 8 is a cross-sectional view of mixer 110 taken along line 7-7 in FIG. 7. FIGS. 7 and 8 will be discussed together. FIGS. 6 and 7 depict mixer 110 with other components of nozzle 102 removed for clarity. More specifically, the view of mixer 110 shown in FIG. 8 is rotated 90° clockwise about axis A-A when mixer 110 is viewed at upstream shaft end 292. FIGS. 7 and 8 show shaft 112, extension 114, mixing channel 116, air channel 120, air inlet 122, air outlet 124, sealing portion 150, upstream channel end 134, downstream channel end 136, upstream shaft end 292, downstream shaft end 294, upstream helix end 296, and downstream helix end 298. FIGS. 7-8 also show helical pitch P, first helical diameter D₁, second diameter D₂, length L of the helix defined by extension 114, and hole axis HA-HA of air outlet 124.

In the depicted example, extension 114 forms a helix that wraps around shaft 112 and extends axially from the upstream end of shaft 112 to the downstream end of shaft 112. Extension 114 has a helical pitch P and a variable helical diameter that decreases from first diameter D₁ to second diameter D₂ along the length L of shaft 112. The diameter of extension 114 decreases in the downstream direction of material flow along mixer 110. First diameter D₁ and second diameter D₂ can be selected to improve fit of mixer 110 against inner housing surface 127. Further, as extension 114 defines mixing channel 116 in combination with shaft 112 and inner housing surface 127, first diameter D₁, second diameter D₂ and pitch P can be sized according to the desired dimensions of mixing channel 116. Extension 114 can be sized to, for example, improve mixing of component materials into a heterogenous mixture upstream of mix point 126, improve concentration uniformity of component materials across mixing channel 116, or adjust another suitable parameter to improve foam quality.

Upstream shaft end 292 defines the upstream end of shaft 112 and downstream shaft end 294 defines the downstream end of shaft 112. Upstream helix end 296 defines the upstream end of extension 114 and downstream helix end 298 defines the downstream end of extension 114. Upstream helix end 296 and downstream helix end 298 are spaced axially-inward (i.e., along axis A-A) from upstream shaft end 292 and downstream shaft end 294, respectively. Upstream helix end 296 and upstream shaft end 292 are spaced according to the desired axial length (i.e., along axis A-A) of shaft seal 125. In other examples, downstream helix end 298 can have the same or substantially the same axial position along axis A-A as downstream shaft end 294.

When mixer 110 is installed in spray nozzle 102, component materials flow through mixing channel 116 from upstream shaft end 292 to downstream shaft end 294. Similarly, as air inlet 122 is disposed at upstream shaft end 292, air also flows from upstream shaft end 292 and toward downstream shaft end 294, and is injected into mixing channel 116 through air outlet 124. As depicted in FIG. 8, upstream shaft end 292 is open (forming air inlet 122) and downstream shaft end 294 of shaft 112 is closed, such that air channel 120 extends only partially axially through shaft 112. Air channel 120 is depicted as extending partially downstream of air outlet 124 in FIG. 8, but in other examples, air channel 120 can be sized such that air outlet 124 is disposed at the downstream end of air channel 120.

In FIGS. 4-8, air outlet 124 is disposed at more than 50% of length L from upstream shaft end 292 of shaft 112. Mixing channel 116 and air outlet 124 are arranged such that air outlet 124 is disposed between 2.5 and 3.5 turns of the mixing channel 116 from upstream channel end 134 of mixing channel 116. Advantageously, placing air outlet 124 at a location along shaft 112 downstream from the entry point of mixing channel 116 and/or at a location following several turns of mixing channel 116 can improve concentration uniformity of component materials in the heterogenous upstream of mix point 126, which can improve attributes (e.g., cell density, cell size, cell uniformity, etc.) of foams sprayed by spray nozzle 102. Similarly, placing air outlet 124 upstream of the downstream shaft end 294 of shaft 112 allows for improved mixing of the air and heterogenous component material mixture to into an aerated, homogenous mixture prior to foam spraying through nozzle orifice 111 by causing the air and component material mixture to continue to mix through additional turns of mixing channel 116 after air is introduced through air outlet 124. Improved mixing of component materials and air into an aerated, homogenous mixture can improve foam quality of foam sprayed by spray nozzle 102.

Air outlet 124 extends along hole axis HA-HA, which is depicted as intersecting with axis A-A and parallel with a plane perpendicular to axis A-A. The depicted orientation of air outlet 124 causes air outlet 124 to emit air in a direction that is generally orthogonal to the flow of fluid through mixing channel 116. In some examples, this can enhance mixing of air with component materials flowing through mixing channel 116 and can accordingly improve the foam characteristics of foams sprayed by spray nozzle 102. In other examples, alternative orientations can enhance mixing of air and component materials to improve the quality of foam sprayed by spray nozzle 102. For example, air outlet 124 can be oriented such that hole axis HA-HA of air outlet 124 does not intersect axis A-A and/or is not parallel with a plane perpendicular to axis A-A. For example, air outlet 124 can be circumferentially canted such that hole axis HA-HA is parallel with a plane perpendicular to axis A-A but does not intersect axis A-A. In these examples, air outlet 124 to emits air into helical channel against the flow of material in the helical channel or with the flow of material in the helical channel. Additionally and/or alternatively, air outlet 124 can be axially canted, such that hole axis HA-HA of air outlet 124 intersects a radial plane centered on and perpendicular to axis A-A.

FIG. 9 is a plan view of mixer 110 similar to FIG. 7 but showing alternative locations of air outlet 124 that produce high-quality plural component foams. FIG. 9 shows shaft 112, extension 114, mixing channel 116, air inlet 122, length L, and pitch P. FIG. 9 also depicts upstream channel end 134, downstream channel end 136, upstream shaft end 292, downstream shaft end 294, upstream helix end 296, downstream helix end 298, and outlet locations 324a-e. In the depiction of mixer 110 shown in FIG. 9, outlet locations 324a, 324b, 324e are on the front of mixer 110 and outlet locations 324c, 324d (indicated by dotted lines) are on the rear side of mixer 110. Outlet location 324a is substantially the same location as the location of air outlet 124 described previously with respect to FIGS. 4-8. As the location of mix point 126 is based on the location of air outlet 124, the outlet locations 324a-324e (collectively herein “outlet locations 324”) described herein are each associated with a different axial location of mix point 126 along axis A-A. More specifically, each location 324a-324e can be used to position mix point 126 along different regions of mixer 110. The specific location of air outlet 124 can be selected from outlet locations 324 or another location in order to improve or affect foam quality.

Outlet locations 324a, 324c, 324d, and 324e are more than 50% of the length L of shaft 112 from upstream shaft end 292, and outlet location 324b is less than 50% of the length L of shaft 112 from upstream shaft end 292. More specifically, outlet location 324c is at approximately 50% of the length L of shaft 112 from upstream shaft end 292, outlet location 324d is at approximately 75% of the length L of shaft 112 from upstream shaft end 292, outlet location 324a is between 50% and 75% (approximately 62.5%) of the length L of shaft 112 from upstream shaft end 292, and outlet location 324e is between 75% and 90% (approximately 87.5%) of the length L of shaft 112.

As used herein, a “turn” or “helical turn” of mixing channel 116 refers to one full 360° turn of mixing channel 116 as defined by pitch P. Two points along extension 114 that are offset by a line parallel to axis A-A and having a length equal to pitch P define one full helical turn of extension 114. Similarly, two axial midpoints of mixing channel 116 offset by pitch P define a full turn of mixing channel 116, such that a portion of mixing channel 116 defined by a single line parallel to axis A-A and extending across three ridges of extension 114 defines a single turn of mixing channel 116. Accordingly, the number of total turns of extension 114 is defined by the ratio of the helical length L and the helical pitch P.

Pitch P of extension 114 is selected such that all outlet locations 324 are disposed between approximately 2 and 4 turns of mixing channel 116. More specifically, outlet location 324b is disposed at approximately 2 turns of mixing channel 116, outlet location 324c is disposed at approximately 2.5 turns of mixing channel 116, outlet location 324a is disposed at approximately 3 turns of mixing channel 116, outlet location 324d is disposed at approximately 3.5 turns of mixing channel 116, and outlet location 324e is disposed at approximately 4 turns of mixing channel 116. In some examples, locating air outlet 124 between 2.5 and 3.5 turns of mixing channel 116 (e.g., between locations 324c and 324d in FIG. 8) creates foam having highly desirable foam characteristics. In yet further of these examples, locating air outlet 124 at approximately 3 turns of mixing channel 116 (e.g., at location 324a), creates foam having improved foam characteristics.

In yet further examples, the location of air outlet 124 can be selected according to the distance of fluid travel through mixing channel 116. The linear distance traveled by fluids through mixing channel 116 can be used to evaluate the degree of mixing of fluids flowing through mixing channel 116 and, accordingly, air outlet 124 can be located at a position on shaft 112 associated with a linear distance where fluids flowing through mixing channel 116 have desirable mixing for aerating and homogenizing at mix point 126 and/or for spraying through nozzle orifice 111 following aeration and homogenization. In some examples, positioning air outlet 124 along shaft 112 at a location corresponding to 4 inches (in.) (about 10.16 centimeters (cm)) of linear travel through mixing channel 116 (as measured at radial midpoints between shaft 112 and inner housing surface 127) from upstream channel end 134 can cause spray nozzle 102 to produce foam having improved characteristics.

The location of air outlet 124 can also be selected based on the percentage of the total linear travel of mixing channel 116. For example, positioning air outlet 124 along shaft 112 at a location corresponding to more than 50% of the linear distance of mixing channel 116 from upstream shaft end 292 can produce high-quality foam. In some examples, positioning air outlet 124 at a location corresponding to approximately 75% of the linear distance of mixing channel 116 as measured from upstream shaft end 292 can cause spray nozzle 102 to produce foam having improved characteristics.

In yet further examples, the position of air outlet 124 can be selected based on a desired mixing time of component materials upstream of air outlet 124. For example, at a given flow rate of component materials, it may be desirable for the component materials to mix for a particular length of time. The position of air outlet 124 can be selected to adjust the linear travel length of mixing channel 116 upstream of air outlet 124 and, accordingly, adjust the dwell time of the component materials upstream of mix point 126 (i.e., the length of time that the component materials take to travel the portion of mixing channel 116 upstream of mix point 126) according to the flow rate of the component materials.

The distance of air outlet 124 from upstream channel end 134, downstream channel end 136, upstream shaft end 292, downstream shaft end 294, upstream helix end 296, and/or downstream helix end 298 can be selected to adjust the location of mix point 126 based on, for example, component material viscosity, the desired aeration of the plural component foam, or another suitable parameter in order to generate foam having desirable foam characteristics (e.g., cell density, cell size, cell uniformity, etc.). Similarly, pitch P of extension 114 can be selected such that mixing channel 116 has, at a particular distance from upstream shaft end 292, a particular number of turns associated with improved mixing of component materials (i.e., mixing upstream of mix point 126) and/or mixing and aeration of the plural component foam (i.e., mixing downstream of mix point 126), and can accordingly also be based on component material viscosity, the desired aeration of the plural component foam, or another suitable parameter in order to generate foam having desirable foam characteristics (e.g., cell density, cell size, cell uniformity, etc.). The location of air outlet 124 both as a function distance and as a function of turns of mixing channel 116 can be adjusted by relocating air outlet 124 along shaft 112 and/or adjusting the pitch P of extension 114. In all examples, locating air outlet 124 in the range of outlet locations 324 produces high-quality foam. Locations 324 are provided as specific examples of locations of outlet 124 and, in other examples, outlet 124 can have a location not specifically depicted in FIG. 9 and spray nozzle 102 can produce high-quality foam having desirable characteristics.

The diameter of air outlet 124 can also be selected to improve foam quality. In some examples, a diameter of between 0.03 in. (about 0.0762 cm) and 0.086 in. (about 0.21844 cm) produces foam having desirable characteristics. In some of these examples, a diameter of approximately 0.06 inches (about 0.1524 cm) can cause the foam sprayed by nozzle 102 to have desirable foam characteristics. Further, the pressure of air flowing through air channel 120 can also be selected to improve foam quality. In some examples, air at a pressure of 40 psi (about 0.276 MPa) produces foam having desirable foam characteristics. Notably, a single air outlet 124 along shaft 112 emitting air from air channel 120 can provide improved foam characteristics over examples having multiple air outlets 124. At least in some examples, iteratively aerating the plural component mixture with outlets at different axial positions along shaft 112 and/or at different locations of mixing channel 116 can result in undesirable component material ratios when the mixture is sprayed by nozzle orifice 111. Further, multiple air outlets 124 can also reduce the velocity of air flowing emitted from air channel 120 into mixing channel 116, potentially reducing the velocity of the material sprayed through nozzle orifice 111 such that flow of plural component foam from spray nozzle 102 is undesirably low.

In FIG. 9, all of outlet locations 324 are depicted as positioned at axial midpoints of mixing channel 116, such that outlet locations 324 are axially-equidistant from axially-adjacent ridges of extension 114. In other examples, air outlet 124 can be positioned such that air outlet 124 is not axially-equidistant from axially-adjacent ridges of extension 114. The dispensing systems and spray nozzles described herein advantageously can be used to produce foams having improved characteristics (e.g., cell density, cell size, cell uniformity, etc.) over conventional dispensing systems and spray nozzles. Further, as the nozzles described herein can be operated at both the relatively high pressures of common foam dispensing systems and at relatively low systems, the nozzles can be integrated into existing systems to improve foam quality and also can be used in less expensive and lower pressure dispensing systems to create high-quality foam.

While air passage 120, air inlet 122, air outlet 124, and air path 142 have been described herein generally as being configured to receive and flow air to mix point 126 for aerating the plural component mixture, in other examples, another suitable gas can be flowed through the heterogenous plural component material. In these examples, the gas flowed into the plural component material at mix point 126 can also be used both to mix the heterogenous plural component material into a homogenous plural component material and to create a foam of the homogenized plural component material. In examples in which air passage 120, air inlet 122, and air outlet 124 are configured to accept and flow other gases in place of or in addition to air, each of air passage 120, air inlet 122, and air outlet 124 can be referred to as a “gas passage,” a “gas inlet,” and a “gas outlet,” respectively.

Although the present invention has been described with reference to preferred embodiments, workers skilled in the art will recognize that changes may be made in form and detail without departing from the spirit and scope of the invention.

### DISCUSSION OF POSSIBLE EMBODIMENTS

The following are non-exclusive descriptions of possible embodiments of the present invention.

An embodiment of a nozzle assembly includes a nozzle housing defining an inner chamber and a mixer disposed within the inner chamber. The mixer defines a flow path and comprising an air channel extending partially through the mixer and the air channel is configured to deliver air to a mix point along the flow path.

The nozzle assembly of the preceding paragraph can optionally include, additionally and/or alternatively, any one or more of the following features, configurations and/or additional components:

An embodiment of a nozzle assembly according to an exemplary embodiment of this disclosure includes, among other possible things, a nozzle housing defining an inner chamber and a mixer disposed within the inner chamber. The mixer defines a flow path and comprising an air channel extending partially through the mixer and the air channel is configured to deliver air to a mix point along the flow path.

A further embodiment of the foregoing nozzle assembly, wherein the mixer comprises a shaft and an extension extending from the shaft. The extension and an inner surface of the nozzle housing define the flow path.

A further embodiment of any of the foregoing nozzle assemblies, wherein the air channel is formed in the shaft.

A further embodiment of any of the foregoing nozzle assemblies, wherein the shaft comprises an inlet orifice and an outlet orifice. The inlet orifice is formed in the first end of a shaft and is fluidly connected to the air channel and the outlet orifice is formed through the shaft between the air channel and an exterior of the shaft at a point location between a first end of the shaft and a second end of the shaft.

A further embodiment of any of the foregoing nozzle assemblies, wherein the outlet orifice is located between a midpoint of the shaft and the second end of the shaft.

A further embodiment of any of the foregoing nozzle assemblies, wherein the outlet orifice is spaced from the first end of the shaft by a distance of between 50% and 75% of a length of the shaft.

A further embodiment of any of the foregoing nozzle assemblies, wherein the extension forms a helix that wraps around the shaft such that the mixing channel is a helical mixing channel.

A further embodiment of any of the foregoing nozzle assemblies, wherein the outlet orifice is disposed at a location along the shaft between 2.5 and 3.5 helical turns of the flow path from an upstream end of the helical flow path.

A further embodiment of any of the foregoing nozzle assemblies, wherein the air channel is configured to deliver air at a location that is not downstream of the mixer.

A further embodiment of any of the foregoing nozzle assemblies, wherein the air channel is configured to deliver air at a location that is not upstream of the mixer.

A further embodiment of any of the foregoing nozzle assemblies, wherein the mixer includes only one outlet orifice.

A further embodiment of any of the foregoing nozzle assemblies, wherein the air channel is configured emit air at a single location, the single location disposed at the mix point.

A further embodiment of any of the foregoing nozzle assemblies, wherein the nozzle assembly is configured to accept a flow of air only at the inlet orifice and is fluidically sealed to air at locations other than the inlet orifice.

A further embodiment of any of the foregoing nozzle assemblies, wherein the nozzle housing includes a nozzle receiver and a nozzle orifice, and the nozzle assembly extends along an axis from the nozzle receiver to the nozzle orifice. The nozzle receiver is configured to receive a first material, a second material, and air. The nozzle orifice is configured to spray an aerated plural component material formed by a mixture of the first material and the second material and the air. The nozzle housing is fluidically sealed along the axis from the nozzle receiver to the nozzle orifice.

A further embodiment of any of the foregoing nozzle assemblies, wherein the first material and the second material are not aerated upstream of the mix point.

A further embodiment of any of the foregoing nozzle assemblies, wherein the first material and the second material are not aerated upstream of the mixer.

A further embodiment of any of the foregoing nozzle assemblies, wherein air is not delivered to the first material or the second material upstream of the mixer.

A further embodiment of any of the foregoing nozzle assemblies, the mixer extends along an axis and the mixer does not include an axial orifice outlet for flowing air to the inner chamber on a downstream axial end of the mixer.

A further embodiment of a nozzle assembly includes a nozzle housing defining an inner chamber and a mixer disposed within the inner chamber. The nozzle housing includes a nozzle receiver and a nozzle orifice. The nozzle receiver is configured to connect to a sprayer housing and to receive a first material, a second material, and air, and the nozzle orifice is for spraying a plural component material formed by a mixture of the first material and the second material. The mixer includes a shaft, an extension, an air channel, an inlet orifice, and an outlet orifice.

The nozzle assembly of the preceding paragraph can optionally include, additionally and/or alternatively, any one or more of the following features, configurations and/or additional components:

An embodiment of a nozzle assembly according to an exemplary embodiment of this disclosure includes, among other possible things, a nozzle housing defining an inner chamber and a mixer disposed within the inner chamber. The nozzle housing includes a nozzle receiver and a nozzle orifice. The nozzle receiver is configured to connect to a sprayer housing and to receive a first material, a second material, and air, and the nozzle orifice is for spraying a plural component material formed by a mixture of the first material and the second material. The mixer includes a shaft, an extension, an air channel, an inlet orifice, and an outlet orifice.

A further embodiment of the foregoing nozzle assembly, wherein the location of the outlet orifice defines a mix point in the mixing channel.

A further embodiment of any of the foregoing nozzle assemblies, wherein the mixing channel is positioned to receive the first material from a first material path and the second material from a second material path.

A further embodiment of any of the foregoing nozzle assemblies, wherein the inlet orifice is positioned to receive air from an air path.

A further embodiment of any of the foregoing nozzle assemblies, wherein the outlet orifice extends through the shaft along an outlet axis and the outlet axis is oriented at an angle relative to the shaft axis.

A further embodiment of any of the foregoing nozzle assemblies, and further comprising a path housing attached to the nozzle receiver and configured to receive the first material, the second material, and the air, wherein the fluid path housing includes a connector configured to connect to the sprayer housing.

A further embodiment of any of the foregoing nozzle assemblies, wherein the path housing defines the first material path and the second material path.

A further embodiment of any of the foregoing nozzle assemblies, wherein the outlet orifice is located between a midpoint of the shaft and the second end of the shaft.

A further embodiment of any of the foregoing nozzle assemblies, wherein the outlet orifice is spaced from the first end of the shaft by a distance of between 50% and 75% of a length of the shaft.

A further embodiment of any of the foregoing nozzle assemblies, wherein the extension forms a helix that wraps around the shaft such that the mixing channel is a helical mixing channel.

A further embodiment of any of the foregoing nozzle assemblies, wherein the location of the outlet orifice is between 2.5 and 3.5 helical turns of the mixing channel from an upstream end of the mixing channel.

A further embodiment of any of the foregoing nozzle assemblies, wherein the upstream end of the mixing channel is adjacent to the first end of the shaft.

A further embodiment of any of the foregoing nozzle assemblies, wherein a helical length of the mixing channel between an upstream end of the mixing channel and first end of the shaft and the mix point is at least four inches.

A further embodiment of any of the foregoing nozzle assemblies, wherein the outlet axis is parallel to a plane orthogonal to the axis.

A further embodiment of any of the foregoing nozzle assemblies, wherein the outlet axis is perpendicular to the shaft axis.

A further embodiment of any of the foregoing nozzle assemblies, wherein the outlet axis intersects the shaft axis.

A further embodiment of any of the foregoing nozzle assemblies, wherein the outlet orifice is cylindrical and has an outlet diameter.

A further embodiment of any of the foregoing nozzle assemblies, wherein the outlet diameter is between about 0.03 inches and about 0.086 inches, inclusive.

A further embodiment of any of the foregoing nozzle assemblies, wherein the outlet diameter is 0.06 inches

A further embodiment of any of the foregoing nozzle assemblies, and further comprising a shoulder formed in the nozzle receiver of the nozzle housing, wherein the nozzle housing narrows at the shoulder in a downstream direction and the shoulder is configured to receive a seal, the downstream direction defined by a direction of flow through the inner chamber from the nozzle receiver to the nozzle orifice.

A further embodiment of any of the foregoing nozzle assemblies, wherein the inner surface of the nozzle housing tapers to narrow a width of a portion of the inner chamber receiving the mixer as the inner chamber extends from the nozzle receiver and towards the nozzle orifice.

A further embodiment of any of the foregoing nozzle assemblies, wherein the extension engages the inner surface of the nozzle housing in an interference fit.

A further embodiment of any of the foregoing nozzle assemblies, wherein the extension is attached to the inner surface of the housing.

A further embodiment of any of the foregoing nozzle assemblies, wherein the second end of the shaft is closed.

A further embodiment of any of the foregoing nozzle assemblies, wherein the air channel is configured to deliver air at a location that is not downstream of the mixer.

A further embodiment of any of the foregoing nozzle assemblies, wherein the air channel is configured to deliver air at a location that is not upstream of the mixer.

A further embodiment of any of the foregoing nozzle assemblies, wherein the nozzle housing is fluidically sealed downstream of the mixer.

A further embodiment of any of the foregoing nozzle assemblies, wherein the nozzle housing is fluidically sealed upstream of the mixer.

A further embodiment of any of the foregoing nozzle assemblies, wherein the mixer is fluidically sealed downstream of the mix point.

A further embodiment of any of the foregoing nozzle assemblies, wherein the mixer is fluidically sealed upstream of the mix point.

A further embodiment of any of the foregoing nozzle assemblies, wherein the mixer includes only one outlet orifice.

A further embodiment of any of the foregoing nozzle assemblies, wherein the mixer does not include a further outlet orifice downstream of the mix point.

A further embodiment of any of the foregoing nozzle assemblies, wherein the mixer does not include a further outlet orifice upstream of the mix point.

A further embodiment of any of the foregoing nozzle assemblies, wherein the air channel is configured emit air at a single location, the single location disposed at the mix point.

A further embodiment of a nozzle assembly includes a nozzle housing forming a mixing chamber, a path housing, and a mixer. The nozzle housing is structured with one open end for connecting with a path housing and the opposite end with a nozzle orifice for spraying foam. The path housing is for receiving compressed air, a first fluid component, and a second fluid component, and is structured to be connected to the nozzle housing. The mixing chamber is structured to fit at least partially within the nozzle housing and to receive compressed air from the path housing, and includes a central shaft, a helical extension, and an air orifice. The central shaft has an internal channel for compressed air. The helical extension is arranged around at least a portion of the central shaft and forms at least two helical turns around the central shaft, thereby creating a helical channel. The air orifice is arranged on the central shaft and is structured to release compressed air from the central shaft at an angle other than a direction of the internal channel.

The nozzle assembly of the preceding paragraph can optionally include, additionally and/or alternatively, any one or more of the following features, configurations and/or additional components:

An embodiment of a nozzle assembly according to an exemplary embodiment of this disclosure includes, among other possible things, a nozzle housing forming a mixing chamber, a path housing, and a mixer. The nozzle housing is structured with one open end for connecting with a path housing and the opposite end with a nozzle orifice for spraying foam. The path housing is for receiving compressed air, a first fluid component, and a second fluid component, and is structured to be connected to the nozzle housing. The mixing chamber is structured to fit at least partially within the nozzle housing and to receive compressed air from the path housing, and includes a central shaft, a helical extension, and an air orifice. The central shaft has an internal channel for compressed air. The helical extension is arranged around at least a portion of the central shaft and forms at least two helical turns around the central shaft, thereby creating a helical channel. The air orifice is arranged on the central shaft and is structured to release compressed air from the central shaft at an angle other than a direction of the internal channel.

A further embodiment of the foregoing nozzle assembly, wherein the air orifice is disposed in the helical channel.

A further embodiment of any of the foregoing nozzle assemblies, wherein the first material and the second material are not aerated upstream of the mix point.

A further embodiment of any of the foregoing nozzle assemblies, wherein the first material and the second material are not aerated upstream of the mixer.

A further embodiment of any of the foregoing nozzle assemblies, wherein air is not delivered to the first material or the second material upstream of the mixer.

A further embodiment of any of the foregoing nozzle assemblies, wherein the mixer extends along an axis and the mixer does not include an axial orifice outlet for flowing air to the inner chamber on a downstream axial end of the mixer.

An embodiment of a sprayer includes a spray housing, the nozzle assembly of another embodiment of a nozzle assembly, and a trigger. The nozzle assembly is connected to the sprayer housing. The trigger is connected to the spray housing and is operatively connected to a valve for selectively permitting the flow of at least one of a first material, a second material, and air to the nozzle assembly.

The sprayer of the preceding paragraph can optionally include, additionally and/or alternatively, any one or more of the following features, configurations and/or additional components:

An embodiment of a sprayer according to an exemplary embodiment of this disclosure includes, among other possible things, a spray housing, the nozzle assembly of another embodiment of a nozzle assembly, and a trigger. The nozzle assembly is connected to the sprayer housing. The trigger is connected to the spray housing and is operatively connected to a valve for selectively permitting the flow of at least one of a first material, a second material, and air to the nozzle assembly.

The further embodiment of the foregoing sprayer, wherein the sprayer housing comprises a handle extending from the sprayer housing.

An embodiment of a method of spraying a plural component material includes flowing a first material through a flow path and flowing a second material through the flow path while flowing the first material through the flow path. The flow path is defined by an interior wall of a nozzle housing and a mixer disposed within the nozzle housing. The method further includes flowing nucleation air through a channel extending through the mixer to an air orifice disposed at a mix point, and mixing the first and the second material with the nucleation air to generate a plural component material. The method further includes spraying the plural component material from a nozzle orifice defined by a first end of the nozzle housing.

The method of the preceding paragraph can optionally include, additionally and/or alternatively, any one or more of the following features, configurations and/or additional components:

An embodiment of a method of spraying a plural component material according to an exemplary embodiment of this disclosure includes, among other possible things, flowing a first material through a flow path and flowing a second material through the flow path while flowing the first material through the flow path. The flow path is defined by an interior wall of a nozzle housing and a mixer disposed within the nozzle housing. The method further includes flowing nucleation air through a channel extending through the mixer to an air orifice disposed at a mix point, and mixing the first and the second material with the nucleation air to generate a plural component material. The method further includes spraying the plural component material from a nozzle orifice defined by a first end of the nozzle housing.

A further embodiment of the foregoing method of spraying a plural component material, wherein the flow path extends helically.

A further embodiment of any of the foregoing methods of spraying a plural component material, wherein the flowing nucleation air through the channel extending through the mixer to an air orifice disposed at a mix point comprises flowing air through the channel extending through a shaft of the mixer.

A further embodiment of any of the foregoing methods of spraying a plural component material, wherein flowing the first material and the second material through the flow path comprises flowing the first material and the second material through a mixing channel defined by an extension extending from the shaft and the interior wall of the nozzle housing.

A further embodiment of any of the foregoing methods of spraying a plural component material, wherein the extension forms a helix that wraps around the shaft.

A further embodiment of any of the foregoing methods of spraying a plural component material, wherein flowing the first material and the second material through the mixing channel comprises flowing the first material and the second material through between 2.5 and 3.5 helical turns of the mixing channel before mixing the first material and the second material with the nucleation air.

A further embodiment of any of the foregoing methods of spraying a plural component material, wherein flowing the first material and the second material through the mixing channel comprises flowing the first material and the second material through 4 inches of linear travel along the mixing channel before mixing the first material and the second material with the nucleation air.

A further embodiment of any of the foregoing methods of spraying a plural component material, wherein flowing the nucleation air to the air orifice comprises flowing the nucleation air at a pressure of 40 pounds per square inch.

A further embodiment of any of the foregoing methods of spraying a plural component material, wherein mixing the first material and the second material with the nucleation air to generate a plural component material comprises aerating the first material and the second material with the nucleation air to generate a plural component foam.

A further embodiment of any of the foregoing methods of spraying a plural component material, wherein spraying the plural component material from the nozzle orifice comprises spraying the plural component foam.

A further embodiment of any of the foregoing methods of spraying a plural component material, wherein flowing nucleation air through the air passage to the air orifice comprises flowing nucleation air to a single air orifice disposed at the mix point.

A further embodiment of any of the foregoing methods of spraying a plural component material, wherein mixing the first material and the second material with the nucleation air to generate a plural component material comprises mixing the first material and the second material only with nucleation air from the air orifice.

An embodiment of a mixing nozzle for spraying a fluid mixture composed of a first material and a second material includes a nozzle orifice for spraying the fluid mixture, an outer tube defining a mixing chamber, a first material outlet, a second material outlet, a static mixer located within the mixing chamber, and an inner tube extending along the axis within the mixing chamber and at least partially surrounded by the static mixer. The outer tube is coaxial with an axis, the mixing chamber is located upstream of the outlet orifice, and the axis extends through the outlet orifice. The first material outlet is configured to flow the first material to be mixed into the mixing chamber and the second material outlet is configured to flow the second material to be mixed with the first material into the mixing chamber. The inner tube includes a gas outlet orifice for introducing compressed gas to a mixture of the first material and the second material at a mix point along the static mixer. The gas outlet orifice is located along the axis between the upstream terminus and the downstream terminus, and the first material outlet and the second material outlet are both located upstream of the gas outlet orifice.

The mixing nozzle of the preceding paragraph can optionally include, additionally and/or alternatively, any one or more of the following features, configurations and/or additional components:

An embodiment of a mixing nozzle for spraying a fluid mixture composed of a first material and a second material includes a nozzle orifice for spraying the fluid mixture according to an exemplary embodiment of this disclosure includes, among other possible things, a nozzle orifice for spraying the fluid mixture, an outer tube defining a mixing chamber, a first material outlet, a second material outlet, a static mixer located within the mixing chamber, and an inner tube extending along the axis within the mixing chamber and at least partially surrounded by the static mixer. The outer tube is coaxial with an axis, the mixing chamber is located upstream of the outlet orifice, and the axis extends through the outlet orifice. The first material outlet is configured to flow the first material to be mixed into the mixing chamber and the second material outlet is configured to flow the second material to be mixed with the first material into the mixing chamber. The inner tube includes a gas outlet orifice for introducing compressed gas to a mixture of the first material and the second material at a mix point along the static mixer. The gas outlet orifice is located along the axis between the upstream terminus and the downstream terminus, and the first material outlet and the second material outlet are both located upstream of the gas outlet orifice.

A further embodiment of the foregoing mixing nozzle, wherein the first material outlet and the second material outlet are both located upstream of the static mixer.

A further embodiment of any of the foregoing mixing nozzles, wherein the static mixer extends along the axis as a continuous structure.

A further embodiment of any of the foregoing mixing nozzles, wherein the static mixer comprises a plurality of segmented structures disposed along the axis.

A further embodiment of any of the foregoing mixing nozzles, wherein the outer tube defines the nozzle orifice.

A further embodiment of any of the foregoing mixing nozzles, wherein the inner tube is coaxial with the axis.

A further embodiment of any of the foregoing mixing nozzles, wherein the static mixer is coaxial with the axis.

A further embodiment of any of the foregoing mixing nozzles, wherein the inner tube is configured to not introduce compressed gas upstream of the static mixer.

A further embodiment of any of the foregoing mixing nozzles, wherein the inner tube is configured to not introduce compressed gas downstream of the static mixer.

A further embodiment of any of the foregoing mixing nozzles, wherein the static mixer is integrally formed with the inner tube.

A further embodiment of any of the foregoing mixing nozzles, wherein the static mixer is joined to an inner surface of the inner tube.

A further embodiment of any of the foregoing mixing nozzles, wherein the compressed gas is not introduced to either of the first material or the second material upstream of the static mixer when spraying in a steady state.

A further embodiment of any of the foregoing mixing nozzles, wherein compressed gas is not introduced to either of the first material or the second material downstream of the static mixer when spraying in a steady state.

1. A nozzle assembly comprising:
a nozzle housing defining an inner chamber; and
a mixer disposed within the inner chamber, the mixer defining a flow path and comprising an air channel extending partially through the mixer;
wherein the air channel is configured to deliver air to a mix point along the flow path.

2. The nozzle assembly of claim 1, wherein the mixer comprises:
a shaft; and
an extension extending from the shaft, wherein the extension and an inner surface of the nozzle housing define the flow path.

3. The nozzle assembly of claim 2, wherein the air channel is formed in the shaft.

4. The nozzle assembly of claim 2, wherein the shaft comprises:
an inlet orifice formed in the first end of a shaft and fluidly connected to the air channel; and
an outlet orifice formed through the shaft between the air channel and an exterior of the shaft at a point location between a first end of the shaft and a second end of the shaft.

5. The nozzle assembly of claim 4, wherein the outlet orifice is located between a midpoint of the shaft and the second end of the shaft.

6. The nozzle assembly of claim 4, wherein the outlet orifice is spaced from the first end of the shaft by a distance of between 50% and 75% of a length of the shaft.

7. The nozzle assembly of claim 2, wherein the extension forms a helix that wraps around the shaft such that the flow path is a helical flow path.

8. The nozzle assembly of claim 7, wherein the outlet orifice is disposed at a location along the shaft between 2.5 and 3.5 helical turns of the flow path from an upstream end of the helical flow path.

9. The nozzle assembly of claim 1, wherein the air channel is configured to deliver air at a location that is not downstream of the mixer.

10. The nozzle assembly of claim 1, wherein the air channel is configured to deliver air at a location that is not upstream of the mixer.

11. The nozzle assembly of claim 4, wherein the mixer includes only one outlet orifice.

12. The nozzle assembly of claim 1, wherein the air channel is configured emit air at a single location, the single location disposed at the mix point.

13. The nozzle assembly of claim 4, wherein the nozzle assembly is configured to accept a flow of air only at the inlet orifice and is fluidically sealed to air at locations other than the inlet orifice.

14. The nozzle assembly of claim 1, wherein:
the nozzle housing includes nozzle receiver and a nozzle orifice;
the nozzle assembly extends along an axis from the nozzle receiver to the nozzle orifice;
the nozzle receiver is configured to receive a first material, a second material, and air;
the nozzle orifice is configured to spray an aerated plural component material formed by a mixture of the first material and the second material and the air; and
the nozzle housing is fluidically sealed along the axis from the nozzle receiver to the nozzle orifice.

15. The nozzle assembly of claim 1, wherein the first material and the second material are not aerated upstream of the mix point.

16. The nozzle assembly of claim 1, wherein the first material and the second material are not aerated upstream of the mixer.

17. The nozzle assembly of claim 1, wherein air is not delivered to the first material or the second material upstream of the mixer.

18. The nozzle assembly of claim 1, wherein:
the mixer extends along an axis; and
the mixer does not include an axial orifice outlet for flowing air to the inner chamber on a downstream axial end of the mixer.

19. A nozzle assembly comprising:
a nozzle housing defining an inner chamber, the nozzle housing including:
a nozzle receiver configured to connect to a sprayer housing and to receive a first material, a second material, and air; and
a nozzle orifice for spraying a plural component material formed by a mixture of the first material and the second material; and
a mixer disposed within the inner chamber, the mixer comprising:
a shaft oriented along a shaft axis, the shaft having a first end and a second end, wherein the second end is oriented towards the nozzle orifice of the nozzle housing;
an extension extending from an outer surface of the shaft to an inner surface of the housing and extending along the shaft, such that the helical extension defines a mixing channel extending between the shaft and the inner surface of the housing;
an air channel defined by an inner surface of the shaft, the air channel extending partially axially through the shaft;
an inlet orifice formed in the first end of the shaft; and
an outlet orifice formed through the shaft between the air channel and the outer surface of the shaft at a location between the first end and the second end.

20.-52. (canceled)

53. A nozzle assembly comprising:
a nozzle housing forming a mixing chamber, the nozzle housing structured with one open end for connecting with a path housing and the opposite end with a nozzle orifice for spraying foam;
the path housing for receiving compressed air, a first fluid component, and a second fluid component, wherein the path housing is structured to be connected to the nozzle housing;
a mixer, the mixer structured to fit at least partially within the nozzle housing and to receive compressed air from the path housing, the mixer further including:
a central shaft having an internal channel for compressed air,
a helical extension arranged around at least a portion of the central shaft, the helical extension forming at least two helical turns around the central shaft, thereby creating a helical channel, and
an air orifice arranged on the central shaft, structured to release compressed air from the central shaft at an angle other than a direction of the internal channel.

54.-84. (canceled)
